(19) United States
(12) Patent Application Publication
(10) Pub. No.: US 2007/0258570 A1
(43) Pub. Date: Nov. 8, 2007

(54) USING SERVICES PROVIDED VIA A COMMUNICATION SYSTEM

(75) Inventors: Jari Selenius, Espoo (FI); Jouko Tenhunen, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/563,651

(22) Filed: Nov. 27, 2006

(30) Foreign Application Priority Data
May 25, 2004 (FI) PCT/FI04/00320

(51) Int. Cl. H04M 3/42

(52) U.S. Cl. 379/201.02

(57) ABSTRACT

The present invention relates to a service portal configured to receive information relating to a number of services provided via a communication network, to represent online the information to a user of user equipment End to provide the user equipment, in response to a selection from the user, with a configuration entity comprising said information for adapting a service logic entity in the user equipment, the service logic entity interfacing the service with features or the user equipment. The present invention relates also to user equipment and a method adapted to embodiments of the invention.

### FIELD OF THE INVENTION

The invention relates to communication systems, and more particularly to using services provided via a communication system, such as online imaging services.

### BACKGROUND OF THE INVENTION

A communication system can be seen as a facility that enables communication sessions between two or more entities such as user terminal and/or other nodes associated with the communication system. Examples of communication systems may include fixed line communication systems, such as a public switched telephone network (PSTN), wireless communication systems, e.g. global system for mobile communications (GSM), general packet radio service (GPRS), universal mobile telecommunications system (UMTS), wireless local area network (WLAN) and so on, and/or other communication networks, such as an Internet Protocol (IP) network and/or other packet switched data networks. Various communication systems may simultaneously be concerned in a connection.

A user may access a communication network by means of any appropriate user equipment (UE), for example a mobile terminal, such as a mobile station (MS), a cellular phone, a personal digital assistant (PDA) or the like, or other terminals, such as a personal computer (PC), or any other equipment operable according to a suitable network protocol, such as a hypertext transfer protocol (HTTP) or a wireless applications protocol (WAP). User equipment may be provided with an appropriate browser using human readable content markup language, such as hypertext markup language (HTML), extensible hypertext markup language (XHTML) or wireless markup language (WML).

Users of a communication system may be offered and provided numerous services, such as two-way or multi-way calls, data communication or multimedia services or simply an access to a network, such as the Internet. User equipment may support short message service (SMS), multimedia message service (MMS), electronic mail (email), Web service interface (WSI) messaging, voice mail, and so on. The services may be offered by an operator of the communication system or by another service provider providing services via the communication system.

In the fixed communication networks, online services, such as online imaging and other file type services, such as online printing services, network storage services and so on, have been developed. For example, a document may be sent from user equipment to a service provider providing online printing services. The service provider may allow user to configure and to preview the document online, for example by means of software (SW) in a server of the service provider. The document may then be printed by the service provider and sent to the user or to another addressee selected by the user. In another example, documents of a user are stored in a network storage provided by a service provider. The user may select one or more documents to be printed and the selected document(s) are printed and delivered by the service provider. Typically this kind of service may be provided by an online imaging service provider, such as a photo lab or the like.

The online service providers may wish to provide information on the services, such as special offers, to the users of the services. Special offers may be provided by distributing offer codes, such as e-mall based offer codes, that need to be referred to by the time of placing an order. In particular in the mobile environment, this kind of solution may be complicated and cumbersome.

Therefore, there is a need to provide Improved tools for using online services, such as online imaging services or the like, in particular within the mobile environment. It may be desirable to ameliorate ease of use and user experience. It may also be desirable to provide online information on services, such as online special offers, to the users of the services,

### SUMMARY OF THE INVENTION

In accordance with an aspect of the invention, there is provided a service portal configured to receive information relating to a number of services provided via a communication network, to represent online the information to a user of user equipment and to provide the user equipment, in response to a selection from the user, with a configuration entity comprising said information for adapting a service logic entity in the user equipment, the service logic entity interfacing the service with features of the user equipment.

In accordance with a further aspect of the invention, there is provided a method for using services provided via a communication system. The method comprises retrieving in user equipment information relating to a service from an online service portal relating to a number of service providers. Furthermore, the method comprises adapting configuring information in the user equipment using said information relating to the service and initiating a connection to the service using said configuring information.

In accordance with a further aspect of the invention, there is provided user equipment configured to retrieve information relating to a service from an online service portal relating to a number of service providers, to adapt configuring information In the user equipment using said information relating to the service and to initiate a connection to the service using said configuring information.

In an embodiment, the configuring information may comprise a configuration file configuring a service logic entity for interfacing the service with features of the user equipment.

The service portal may receive updated information from the number of services. The information may be an offer relating to the service.

### BRIEF DESCRIPTION OF THE DRAWINGS

The invention will now be described in further detail, by way of example only, with reference to the following examples and accompanying drawings, in which:

FIG. 1 shows an example of a system in which the embodiments of the invention may be implemented;

FIG. 2 shows an embodiment of the invention;

FIG. 3 shows a further embodiment of the invention; and

FIG. 4 shows a flowchart illustrating an embodiment of the invention.

### DETAILED DESCRIPTION OF PREFERRED EMBODIMENTS

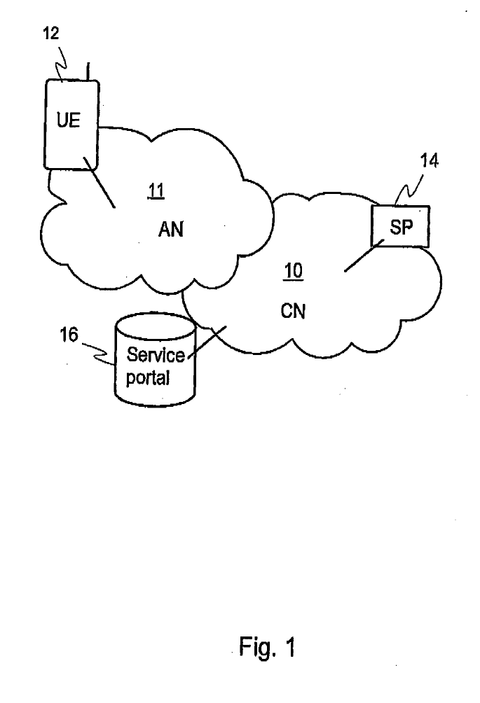

FIG. 1 shows an example of a network architecture in which the embodiments of the invention may be Implemented. FIG. 1 shows a communication network (CN) 10, an access network (AN) 11, user equipment (UE) 12 and a server of a service provider (SP) 14. In the arrangement of FIG. 1, the user equipment 12 may access the communication network 10 via the access network 11 or an access link. Examples of possible access networks and access links may comprise, but are not limited to a cellular network, e.g. a GPRS network, a wireless local area network (WLAN), Bluetooth connection and so on. The communication network 10 may be provided at least in part by means of an IP network, such as the Internet Furthermore, a service portal 16 is shown in FIG. 1. The service portal 16 may be a server common to a plurality of services. Function of the exemplifying service portal 16 will become clear from the following description.

It shall be appreciated that, although for clarity reasons FIG. 1 shows only one user equipment, one server of a service provider and one access network, a typical communication network system usually includes a number of these entities. Depending on the communication system, the terminology used in connection with entities having similar function may also very.

The present invention provides a control framework, preferably resident in mobile user equipment, such as a mobile station. The control framework may be embedded in appropriate location in the user equipment, such as in an image gallery application of the user equipment In an alternative, the control framework may be embedded in another application In the user equipment and used through a standard Application Programming Interface (API) of the user equipment. The control framework provides a platform in the user equipment enabling functioning in accordance with requirements of the user equipment and/or settings of the user and, at the same time, enabling service providers to provide their services In accordance with requirements and/or settings of each service provider. The control framework consists of a plurality of native or add-on functionalities with APis, through which generic functionalities and applications of the user equipment may be accessed. Such generic functionalities and applications may include, but are not limited to an application interworking interface in the user equipment, connectivity software components, other applications, such as Wallet application, Contact Book application, Media Manager application, camera client, MMS client and so on.

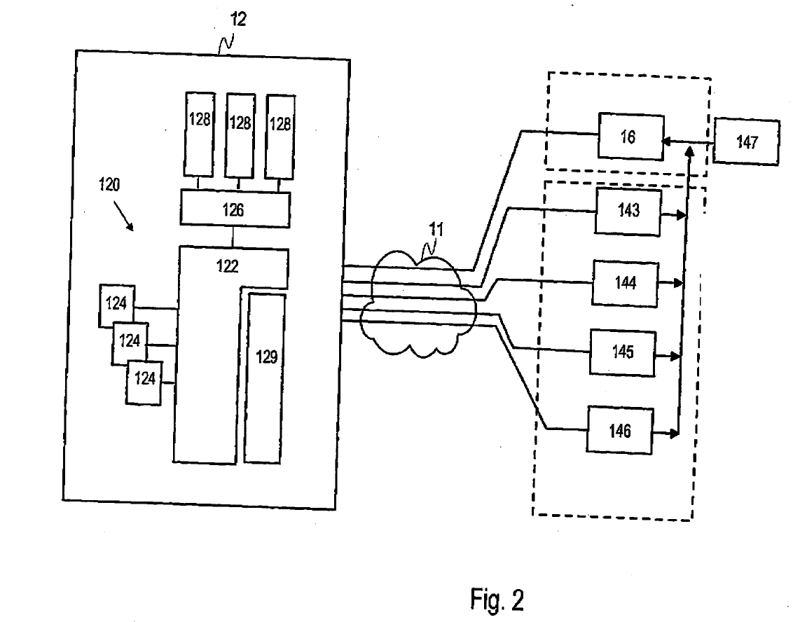

FIG. 2 shows an exemplifying control framework 120 provided in user equipment 12 connected to servers 143, 144, 145, 146 of service providers and to a service portal 16. The control framework 120 is connected to the servers 143, 144, 145, 146 and to the service portal 18 via a communication system, for example, as shown in FIG. 1. The connection may be routed via an access network 11 comprising an access node, such as a gateway OPRS support node or a performance enhancing proxy. The access node may comprise both chargeable access points and free access points depending, for example, on the type of service.

The control framework 120 may comprise at least one service logic entity 122, also called a plug-in, at least one configuration entity or configuration file 124 and control framework's common functionalities 129, such as an HTTP uploader and so on.

The service logic entity 122 Is a resident or downloadable block implementing functionalities of services in user equipment and for interfacing with user equipment features or software. The service logic 122 may utilise generic functionalities and applications 128 of the user equipment through an application interworking interface 126. The service logic 122 provides application logic and may contain parameters relating to the user equipment, end-user preferences and the service provider. There may be a plurality of service logic entities 122, for example one service logic entity for each service category. A service category is a category providing a certain type of service and may be configured by multiple service providers, as will be explained in the following.

The configuration entity or configuration file 124 is a resident or downloadable block for providing parameters to the service logic 122 of the user equipment permitting the user to operate the user equipment features In a manner defined by a third party, such as a service provider. Thus, the configuration file 124 may be used for configuring the service logic entity 122 to function in a service provider specific manner, such as a service provider providing an online Imaging service and hosting a server 143, 144, 145, 146 for the service. There may be a plurality of configuration files 124, each configuration file relating to a different service provider and for a plurality of configuration files relating to,a service provider. As was mentioned above, a service category is hosted in a service logic entity and may be configured by multiple service providers, i.e. using multiple configuration files, for example one configuration file per each service within one service category. Examples of service categories may include, but are not limited to, printing service category, network storage category, file sharing category, and so on.

The configuration file(s) 124 may also permit the user to interact via the control framework 120 with a server 143, 144, 145, 146 as defined within the configuration file 124 by the third party. Interaction may be realised by means of embedded service activation links and application to use the service, such as online imaging service. For example, the control framework 120 may be provided by browser-type functionality in the user equipment. Interaction may include, but is not limited to, receiving updated configuration files, promotional material, and so on.

Servers 143S 144, 145, 146 may be servers of only one service provider or of a plurality of service providers, such as different photo labs. Blocks denoting servers 143, 144, 145, 146 in FIG. 2 may comprise a server of a service category or a server of one service provider. For example, In an online imaging service embodiment, servers 143, 144, 145, 148 may provide, but are not limited to, online album service for storing files, such as image files, online printing service for printing files, online Weblog service for sharing files with other users, and so on.

In an embodiment, a service portal 16 may be provided as a common platform for service providers to offer their services. The service portal 10 may be provided by an operator of the communication network 10 or by another appropriate service provider, The service portal 16 may also receive material from other sources 147 to be presented to the user. Protocols used for operation between the service portal 16 and a client counterpart In the user equipment 12 may comprise HTTP, WAP, XHTML and other appropriate protocols.

The service portal 16 may provide information, such as configuration files, on individual services. Furthermore, the service portal 16 may group the services in different groups such as selected service categories, selected service providers, all available service providers in a service category and so on. The Information provided by the service portal 16 may be viewed and used by a user of the user equipment via the access network 11 and the communication network 10 and may be transmitted to the user equipment 12 on a request from the user equipment in an embodiment, the service portal 16 may be introduced to the control framework as an independent server, which needs not to be tied to a particular online service.

In an embodiment, services 143, 144, 145, 146 may be directly in connection with the user equipment 12. A service link and respective configuration file may be pro installed in the user equipment The user may be displayed and allowed to select a service link, for example, in the Media Manager application.

The configuration file preferably contains parameters only. Parameters of the configuration file may be divided in core parameters and dynamical parameters. The core parameters may be static, such as provided by a service provider by the time of activating a configuration file relating to a service of the service provider. The dynamical parameters may be changed during the lifetime of the configuration file. Preferably, the latest parameter Information is stored in the configuration file. The latest parameter information may also comprise a list of latest parameters, which is handled, for example, following the first-in-first-out principle.

The core parameters may comprise user interface (UI) elements, such as icons, for rendering the UI according to settings provided by the service provider, such as wishes or requirements of the service provider. Furthermore, the core parameters may comprise Information, which allows a user to contact the service provider, such as an uniform resource locator (URL) address. UI elements may be rendered into predefined placeholders on then screen. Furthermore, the core parameters may comprise menu items for enabling the service provider to provide information, such as service names, in pull-down menus of the user equipment. Other appropriate core parameters may be included.

The dynamical parameters may comprise information on the service use. Examples may comprise, but are not limited to, stating that a certain special offer has been used and shall not be available any more, or an order history, for example, in a first-in-first-out list of previous orders. Other appropriate dynamical parameters may be included. Dynamical parameters may be changed and updated by a user, for example, by means of Input-output devices relating to the user equipment In an embodiment, an application in the user equipment may change and update the dynamical parameters automatically and/or in response to an occurrence, such as use of an offer. Dynamical parameters may also be changed and updated by the service provider, for example, by transmitting information from the server to the user equipment.

The service logic entity 122 and the configuration file(s) 124 may be provided by different parties, such as user equipment manufacturer or service providers. For example, the service logic entity 122 may be installed in user equipment 12 during manufacture or downloaded later. A service logic entity 122 may be downloaded for each service category, for example.

In an embodiment, the service logic entity 122 may be provided by a third party, such as a service provider. In that case, it may be third party dependent whether other service providers are allowed to customise the service with their own configuration file.

A configuration file 124 may be downloaded any time and for each service. The configuration files may be downloaded from the service portal 16 or a server 143, 144, 145, 146 of a service provider using appropriate protocols, such as the HTTP.

Service providers may be provided with a tool to create standard format information in an electronic file, such as special offers in a form of e-coupon comprising information associated with a configuration file. For example, the e-coupon may comprise an offer relating to a service and a link to a corresponding configuration file. In a preferred embodiment, the standard format information is transmitted to the service portal 16, which may be common to a plurality of service providers. The standard format information, such as new or updated configuration files, offers and e-coupons, may be delivered to the service portal 16, for example by means of the Really Simple Syndication (RSS) protocol feed.

The standard format information may have any appropriate format. Examples may comprise .sls or .xml format files. In an embodiment, an offer for example in a form of e-coupon is provided in a sis-file separate from a relating configuration file. This allows the configuration file to be installed or not installed before fetching Fe offer or allows overriding or not overriding an existing configuration file. Use of the offer may be initiated even if the relating configuration file is not installed in the user equipment.

In an embodiment, the configuration file comprises the offer incorporated therein.

In the user equipment, a browser or a similar general application comprising or connected to the service logic 122 may take care of retrieving and Installing a configuration fife to the control framework 120. In an alternative, retrieving and installing configuration files may be performed by a function embedded in the service logic. The e-coupon or the like may be passed to the service logic 122 of the control framework 120 and the service logic 122 may be able to link the e-coupon to the relating configuration file. As mentioned above, the configuration may have been pre-installed, downloaded in the control framework 120 earlier or in response to a request to use the offer.

In an embodiment, the e-coupon or the like may be stored as a dynamical parameter in the configuration file, for example for a later use. When the e-coupon or the like is returned to the service logic 122, the service logic 122 may invoke a connection to the respective service. Before the connection, the service logic 122 may estimate the price of an order by using the Information within the e-coupon.

However, the server 143, 144, 145 146 of a respective service provider may calculate the final price once the validity of the e-coupon is checked by the server itself.

The user interface of the user equipment may be provided with a “Special Offers” icon or the like. Preferably, a “Special Offers” icon is provided for each service category. For example, under a service category “Print”, only offers related to printing will be showed.

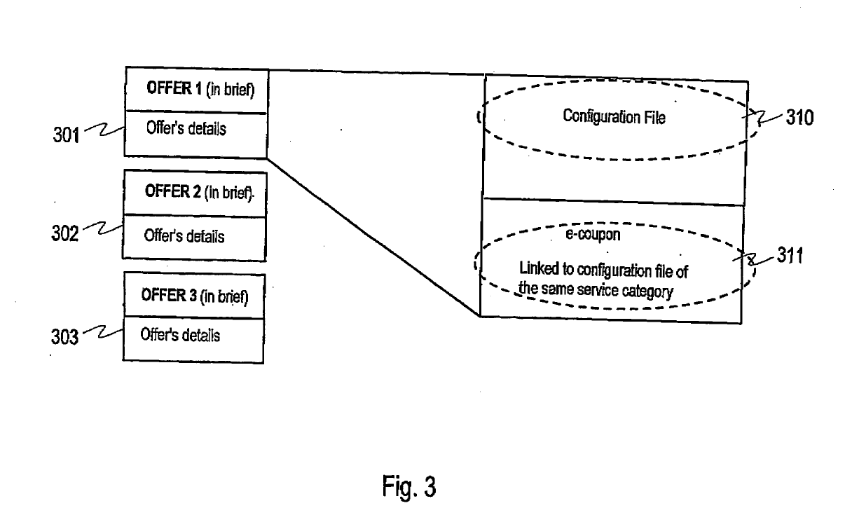

FIG. 3 shows an example of offers 301, 302, 303 including configuration files 310 and e-coupons 311. Users can retrieve offers from the service portal 16. In an alternative solution, offers may be retrieved from a server of each service provider separately. In a further alternative solution, offers may be retrieved partly from the service portal 16 and partly from servers of service providers. The offers 301, 302, 303 may then be constructed to a same user interface view In the user equipment in an embodiment, the offers may be retrieved from the service portal 16, which on its behalf fetches online offers from servers of service providers.

In order to get an offer granted, e-coupons or similar standard format electronic information retrieved in advance may be required. An offer may be such that it Is granted only once, although a user would access multiple times the service portal providing offers. For example, distribution of e-coupons may be limited to a number, such as to one, per a user. In that case mechanisms may be included in the user equipment to ensure that a single user cannot use a special offer more than is allowed although the user could download an e-coupon to the terminal. Such a mechanism may be based on information comprised in the dynamical parameters of the configuration file relating to said offer. However, the mechanism is not limited to this exemplifying embodiment, but may be based on other features as well. In an embodiment, the respective server 143, 144, 145, 146 of the service provider may verify a number of use attempts and a number of allowed use times for the user equipment trying to use the service. A check may be done at the time of fetching special offers, i.e. before the online service is activated or in the beginning of the online service session.

In an embodiment, use of the offer may be Initiated even if the relating configuration file is not installed in the user equipment. If a required configuration file does not exist in the user equipment before selecting an offer, the configuration file may be first downloaded and Installed. It may be irrelevant from the point of view of a special offer whether the configuration file was installed or not before selecting an offer. However, claiming a special offer, within a service category, requires the corresponding configuration file.

The principle of granting offers may be controlled based on rules of service providers, for example. Offers may be granted only if a special offer was fetched from the service portal before an online service was activated. For example, if a user does not have an e-coupon at the time of order, the offer may not be granted.

In an embodiment e-coupons being valid for a longer time, such as during a weekend, may exist. Such e-coupons may not need to be fetched from the service portal 16 before each order. In an embodiment, such e-coupons may be stored as a dynamical parameter in the configuration file.

Using e-coupons may not exclude a service provider providing offers based on some other rules. In an embodiment, the service provider may provide special price for all subscribers and all orders without a need to have an e-coupon.

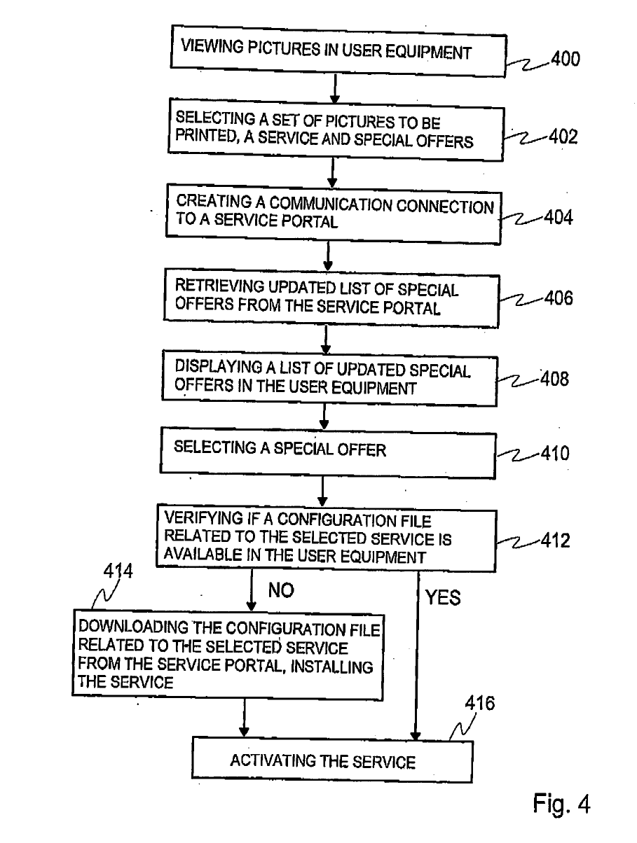

FIG. 4 shows a flow diagram of an exemplifying embodiment of the invention. In step 400, a user views pictures in the Image gallery of the user equipment used by the user. In step 402, the user selects, for example by means of control buttons of the user equipment, a set of pictures to be printed, online printing and special offers. In step 404, the user equipment creates a communication connection, such as a GPRS connection, to a service portal. In step 406, the user equipment retrieves updated list of special offers from the service portal. The special offers may in this case be, for example only printing related or all available special offers. In step 408, the user equipment displays a list of updated special offers to the user. The user can be allowed to view details of any selected special offer. In step 410, the user selects one or more of the special offers. In step 412, the user equipment, for example the service logic entity in the user equipment, verifies if a configuration file related to the selected service is available in the user equipment In an embodiment, a need for a particular configuration file may be Informed by the service portal In any of steps 406 or 408. The user can request the configuration file to be downloaded If necessary, i.e. If the required configuration file does not exist in the user equipment. If the configuration file does not exist in the in the user equipment, the configuration file is downloaded from the service portal and the service, in this example the online printing service, is installed in step 414. In step 416, the service is activated. If a configuration file related to the selected service exists in the user equipment the user equipment directly activates the service in step 416. The service portal or the service logic entity of the user equipment may take care that the user is provided with the advertised offer.

Although the invention has been described in the context of particular embodiments, various modifications are possible without departing from the scope and spirit of the invention as defined by the appended claims. It should be appreciated that whilst embodiments of the present invention have mainly been described in relation to mobile user equipment such as mobile terminals, embodiments of the present invention may be applicable to other types of user equipment that may access communication networks. Furthermore, the communication system may be any appropriate communication system, even if reference has mainly been made to mobile communication systems.

1. A service portal configured to:
receive information relating to a number of services provided via a communication network;
represent online the information to a user of user equipment; and
provide the user equipment, in response to a selection from the user, with a configuration entity comprising said information for adapting a service logic entity in the user equipment, the service logic entity interfacing the service with features of the user equipment.

2. A service portal according to claim 1, configured to receive updated information from the number of services.

3. A method for using services provided via a communication system, the method comprising:
retrieving in user equipment information relating to a service from an online service portal relating to a number of service providers;
adapting configuring information in the user equipment using said information relating to the service; and
initiating a connection to the service using said configuring information.

4. A method according to claim 3, wherein adapting comprises adapting a configuration file configuring a service logic entity for interfacing the service with features of the user equipment.

5. A method according to claim 3, wherein retrieving comprises retrieving updated information relating to the service.

6. A method according to claim 5, wherein retrieving comprises retrieving information on an offer relating to the service.

7. A method according to claim 6, wherein initiating comprises informing the service about using the offer.

8. A computer program comprising program code embodied on a computer readable medium the computer code configured for performing the method of claim 3.

9. User equipment configured to:
retrieve information relating to a service from an online service portal relating to a number of service providers;
adapt configuring information in the user equipment using said information relating to the service; and
initiate a connection to the service using said configuring information.

10. A system comprising a communications network, a service portal and user equipment, the user equipment comprising a service logic entity, wherein the user equipment is configured to download information from the service portal via the communication network for adapting the service logic entity.

11. A computer program comprising program code embodied on a computer readable medium, the computer code configured for performing the method of claim 4.

12. A computer program comprising program code embodied on a computer readable medium, the computer code configured for performing the method of claim 5.

13. A computer program comprising program code embodied on a computer readable medium, the computer code configured for performing the method of claim 6.

14. A computer program comprising program code embodied on a computer readable medium, the computer code configured for performing the method of claim 7.

15. A method according to claim 4, wherein retrieving comprises retrieving updated information relating to the service.

16. A method according to claim 15, wherein retrieving comprises retrieving information on an offer relating to the service.

17. A method according to claim 16, wherein initiating comprises informing the service about using the offer.

18. A computer program comprising program code embodied on a computer readable medium, the computer code configured for performing the method of claim 15.

19. A computer program comprising program code embodied on a computer readable medium, the computer code configured for performing the method of claim 16.

20. A computer program comprising program code embodied on a computer readable medium, the computer code configured for performing the method of claim 17.
